(19) United States
(12) Patent Application Publication
(10) Pub. No.: US 2014/0059014 A1
(43) Pub. Date: Feb. 27, 2014

(54) VALIDATING SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HON HAI PRECISION INDUSTRY CO., LTD., New Taipei (CN); HONG FU JIN PRECISION INDUSTRY (ShenZhen) CO., LTD., Shenzhen (CN)

(21) Appl. No.: 13/967,223

(22) Filed: Aug. 14, 2013

(30) Foreign Application Priority Data
Aug. 21, 2012 (CN) 2012102986815

(51) Int. Cl. G06F 11/00

(52) U.S. Cl. CPC G06F 11/004
USPC 707/690

(57) ABSTRACT

A computer reads an element information list from a file stored in a database of the computer, and generates first element identifiers according to the element information list. The computer marks a second element identifier in content of the file, in response to a determination that the first element identifier is different from the second element identifier corresponding to the first element identifier.

### BACKGROUND

1. Technical Field

The embodiments of the present disclosure relate to management technology, and particularly to a validating system and method. 2. Description of Related Art

A technical file (e.g., a patent application file) may include a plurality of elements (e.g., computers), and each element may be labeled an element name and an element reference number (e.g., a computer 10). At present, the element names and the element reference numbers are manually checked by a user, and the manual check may be very time-consuming. For example, if each element name or each element reference number repetitively appear in the patent application file, the user may take a lot of time to check if all of them are correct. Furthermore, if the file is very long (e.g., fifty pages), it is also difficult for the user to check each element name and each element reference number. Therefore, there is room for improvement in the art.

### BRIEF DESCRIPTION OF THE DRAWINGS

FIG. 1 is a block view of one embodiment of a computer including a validating system.

FIG. 2 is a block diagram of one embodiment of function modules of the validating system included in the computer in FIG. 1.

FIG. 3 is a flowchart of one embodiment of a validating method.

FIG. 4 illustrates one embodiment of a file.

FIG. 5 illustrates another embodiment of the file.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

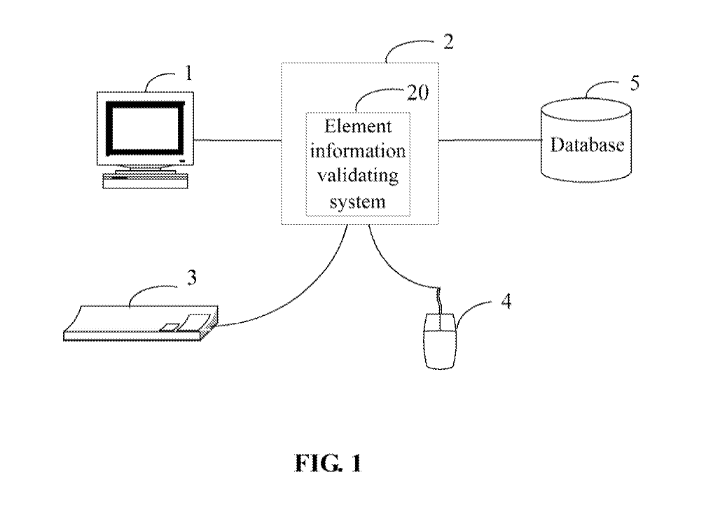

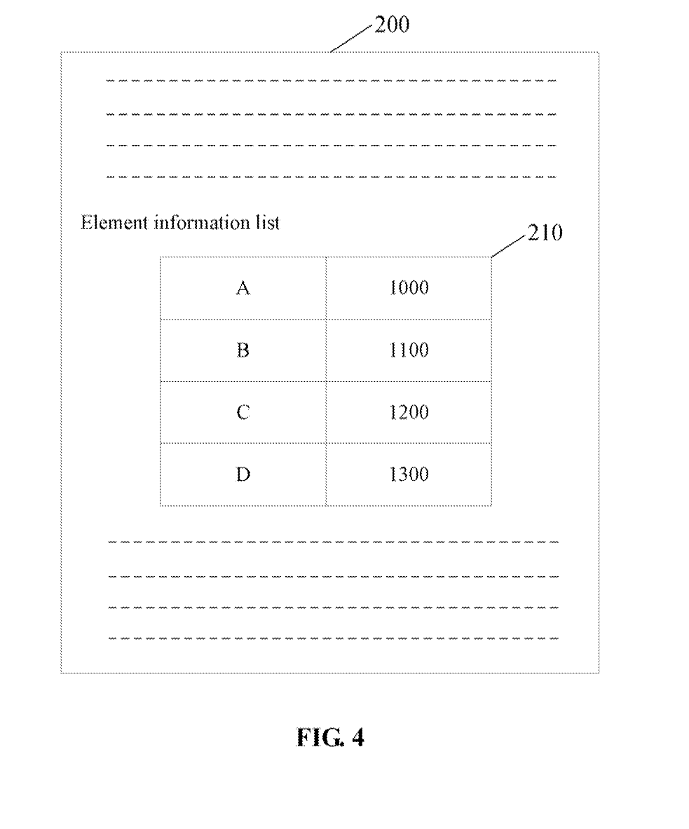

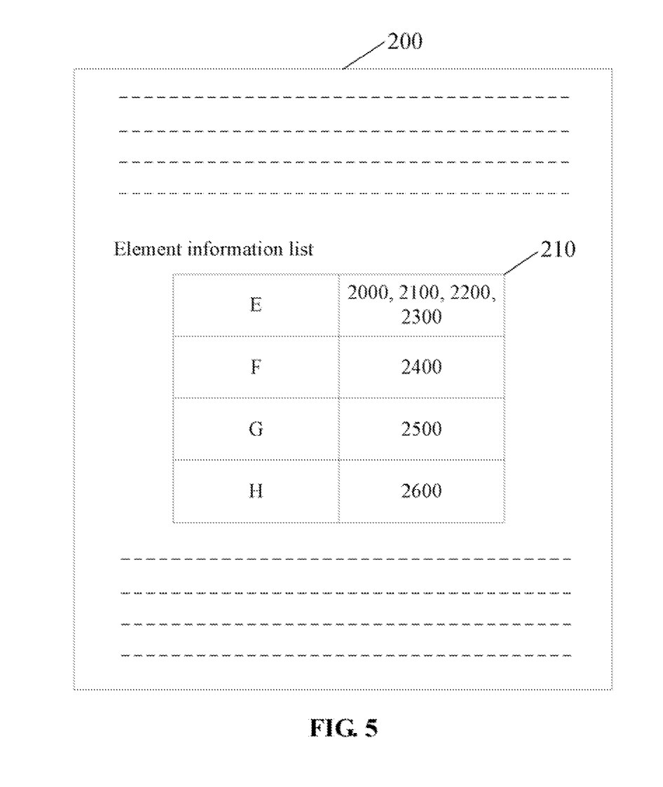

FIG. 1 is a block diagram of one embodiment of a computer 2. In this embodiment, the computer 2 includes a validating system 20. The computer 2 includes a plurality of peripherals that electronically are connected to the computer 2, such as a displaying device 1, a keyboard 3, and a mouse 4. The peripherals may be used to input or output various computer signals or interfaces. The computer 2 electronically connects to a database 5 using open database connectivity (ODBC) or java database connectivity (JDBC), for example. The database 5 may store one or more files 200 as shown in FIG. 4 or FIG. 5. The one or more files 200 may be, but are not limited to, a WORD file, a PDF file, a TXT file, an extensible markup language (XML) file or a hypertext markup language (HTML) file. Each file 200 includes an element information list 210 and a content part (e.g., text content). The element information list 210 includes element names (e.g., A, B, C, and D as shown in FIG. 4) and element reference numbers (e.g., 1000, 1100, 1200 and 1300 as shown in FIG. 4). Each element name corresponds to one or more element reference numbers. For example, as shown in FIG. 4, the element name A corresponds to the element reference number 1000, the element name B corresponds to the element reference number 1100, the element name C corresponds to the element reference number 1200, and the element name D corresponds to the element reference number 1300. Furthermore, for example, as shown in FIG. 5, the element name E corresponds to the element reference numbers 2000, 2100, 2200, and 2300.

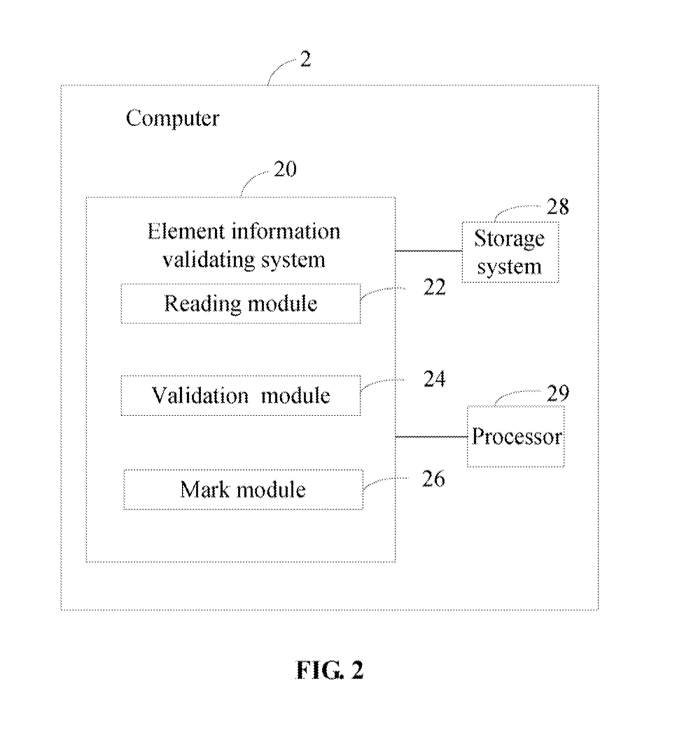

FIG. 2 is a block diagram of one embodiment of function modules of the validating system 20 included in the computer 2 of FIG. 1. The validating system 20 is used to check element information in a file. In one embodiment, the computer 2 includes a storage system 28, and at least one processor 29. In one embodiment, the validating system 20 includes a reading module 22, a validation module 24, and a mark module 26. The modules 22-26 may include computerized code in the form of one or more programs that are stored in the storage system 28. The computerized code includes instructions that are executed by the at least one processor 29 to provide functions for the modules 22-26. The storage system 28 may be a memory, such as an EPROM memory chip, hard disk drive (HDD), or flash memory stick.

The reading module 22 reads an element information list 210 from the file 200, generates first element identifiers according to the element information list and temporarily stores the first element identifiers into the storage system 28. In one embodiment, the reading module 22 reads an element name and an element reference number corresponding to the element name from the element information list in order, combines the element name with the element reference number to generate a first element identifier, and stores the first element identifier into the storage system 28. Additionally, if the element name corresponds to two or more element reference numbers, the element name is respectively combined with each corresponding reference number to generate more than one first element identifier.

The validation module 24 validates if each first element identifier in the storage system is the same as a second element identifier corresponding to the first element identifier. Each second element identifier also includes the element name and the element reference number. The second element identifier corresponds to the first element identifier upon the condition that both the second element identifier and the first element identifier include the same element name or the same element reference number. Additionally, each first element identifier may correspond to one or more second element identifiers. In one embodiment, the invention takes one second element identifier corresponding to the first element identifier as an example for description below.

In one embodiment, the second element identifier is generated as follows: obtaining an element name from the first element identifier and calculating a character length of the element reference number corresponding to the obtained element name, searching for the obtained element name in the content of the file, and obtaining characters in the content of the file according to the character length of the element reference number, where the obtained characters are behind and next to the searched element name, combining the searched element name with the obtained characters to generate the second element identifier in the content of the file.

For example, as shown in FIG. 4, the element name A is obtained from the first element identifier A1000 and the character length of the element reference number 1000 is calculated as four, the validation module 24 searches for the element name A in the content of the file, if the content of the file includes the element name A, the validation module 24 obtains four characters which are behind and next to the searched element name A in the content of the file, and generates the second element identifier by combining the element name A with the four characters. Then the validation module 24 compares the first element identifier A1000 in the storage system with the second element identifier in the content of the file, and determines whether the two element identifies are the same.

In another embodiment, the second element identifier is generated as follows: obtaining an element reference number from the first element identifier and calculating a character length of the element name corresponding to the obtained element reference number, searching for the obtained element reference number in the content of the file, and obtaining the characters in the content of the file according to the character length of the element name, which the obtained characters are prior to and next to the searched element reference number, combining the searched element reference number with the obtained characters to generate the second element identifier in the content of the file.

For example, as shown in FIG. 4, the element reference number 1000 is obtained from the first element identifier A1000 and the character length of the element name A is calculated as one. The validation module 24 searches for the element reference number 1000 in the content of the file, if the content of the file includes the element reference number 1000, the validation module 24 obtains one characters prior to and next to the searched element reference number 1000 in the content of the file, and generates the second element identifier by combining the element reference number 1000 with the one character. Then the validation module 24 compares the first element identifier A1000 in the storage system with the second element identifier in the content of the file, and determines whether the two element identifies are the same.

The mark module 26 marks the second element identifier in the content of the file, in response to a determination that the first element identifier is different from the second element identifier corresponding to the first element identifier. In one embodiment, the mark module 26 highlights the second element identifier in the content of the file. For example, if the second element identifier is different from the first element identifier, the mark module 26 highlights the second element identifier in a specific color, such as red, or underlines the second element identifier. The mark module 26 may also output a report to show position information of the second element identifier, thereby users may find the second element identifier in the content of file easily and quickly.

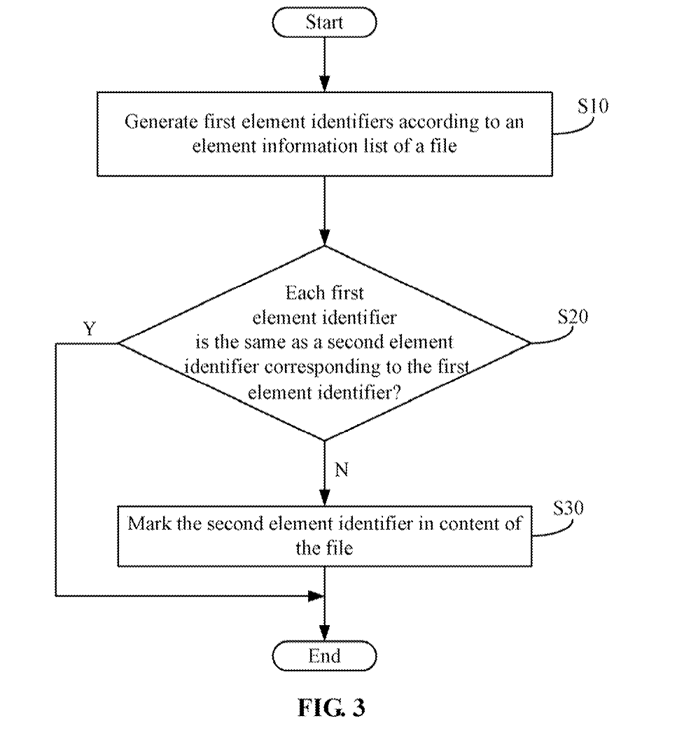

FIG. 3 is a flowchart of one embodiment of a validating method. Depending on the embodiment, additional steps may be added, others deleted, and the ordering of the steps may be changed.

In step S10, the reading module 22 reads an element information list 210 from the file 200, generates first element identifiers according to the element information list and temporarily store the first element identifiers into a storage system 28. As mentioned above, the reading module 22 reads an element name and an element reference number from the element information list in order, and combines the element name with the element reference number corresponding to the element name, and generates a first element identifier, then the first element identifier is stored into the storage system 28. For example, as shown FIG. 4, the element name A is combined with the element reference number 1000, and the first element identifier A1000 is generated and stored into the storage system 28. Additionally, if the element name corresponds to two or more element reference numbers, the element name is respectively combined with each corresponding reference number. As shown in FIG. 5, the element name E corresponds to the element reference numbers 2000, 2100, 2200, and 2300, the first element identifiers E2000, E2100, E2200, and E2300 are generated and stored into the storage system 28.

In step S20, the validation module 24 validates if each first element identifier in the storage system is the same as a second element identifier corresponding to the first element identifier. As mentioned above, if the second element identifier includes the element name A, and the first element identifier also include the same element name A, the element reference number in the second element identifier may be different from the element reference number in the first element identifier, the second element identifier corresponds to the first element identifier. Additionally, if the second element identifier includes the element reference number 1000, and the first element identifier also includes the same element reference number 1000, the element name in the second element identifier may be different from the element name in the first element identifier, the second element identifier also corresponds to the first element identifier. In one embodiment, if the first element identifier in the storage system is different from the second element identifier corresponding to the first element identifier, the procedure goes to step S30. Otherwise, if the first element identifier in the storage system is the same as second element identifier corresponding to the first element identifier, the procedure ends.

In step S30, the mark module 26 marks the second element identifier in the content of the file, in response to a determination that the first element identifier is different from the second element identifier corresponding to the first element identifier. For example, if the second element identifier is different from the first element identifier, the mark module 26 highlights the second element identifier in a specific color, such as red, or underlines the second element identifier. The mark module 26 may also output a report to show position information of the second element identifier, thereby users may find the second element identifier in the content of file easily and quickly.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
at least one processor; and
a storage system that stores one or more programs, when executed by the at least one processor, cause the at least one processor to perform a validating method, the method comprising:
reading an element information list from a file stored in a database of the computer, generating first element identifiers according to the element information list;
validating if each first element identifier in the storage system is the same as a second element identifier corresponding to the first element identifier; and
marking the second element identifier in content of the file, in response to a determination that the first element identifier is different from the second element identifier corresponding to the first element identifier.

2. The computer of claim 1, wherein the element information list comprises element names and element reference numbers, and each element name corresponds to one or more element reference numbers.

3. The computer of claim 2, wherein the first element identifier is generated by combining an element name with an element reference number corresponding to the element name.

4. The computer of claim 3, wherein the second element identifier is generated as follows:
obtaining the element name from the first element identifier and calculating a character length of the element reference number corresponding to the obtained element name;
searching for the obtained element name in the content of the file, and obtaining characters in the content of the file according to the character length of the element reference number, wherein the obtained characters are behind and next to the searched element name; and
combining the searched element name with the obtained characters to generate the second element identifier in the content of the file.

5. The computer of claim 3, wherein the second element identifier is generated as follows:
obtaining the element reference number from the first element identifier and calculating the character length of the element name corresponding to the obtained element reference number;
searching for the obtained element reference number in the content of the file, and obtaining the characters in the content of the file according to the character length of the element name, where the obtained characters are prior to and next to the searched element reference number; and
combining the searched element reference number with the obtained characters to generate the second element identifier in the content of the file.

6. The computer of claim 3, wherein the second element identifier corresponds to the first element identifier upon the condition that both the second element identifier and the first element identifier include the same element name or the same element reference number.

7. A validating method implemented by a computer, the method comprising:
reading an element information list from a file stored in a database of the computer, generating first element identifiers according to the element information list;
validating if each first element identifier in the storage system is the same as a second element identifier corresponding to the first element identifier; and
marking the second element identifier in the content of the file, in response to a determination that the first element identifier is different from the second element identifier corresponding to the first element identifier.

8. The method of claim 7, wherein the element information list comprises element names and element reference numbers, and each element name corresponds to one or more element reference numbers.

9. The method of claim 8, wherein the first element identifier is generated by combining an element name with an element reference number corresponding to the element name.

10. The method of claim 9, wherein the second element identifier is generated as follows:
obtaining the element name from the first element identifier and calculating a character length of the element reference number corresponding to the obtained element name;
searching for the obtained element name in the content of the file, and obtaining characters in the content of the file according to the character length of the element reference number, wherein the obtained characters are behind and next to the searched element name; and
combining the searched element name with the obtained characters to generate the second element identifier in the content of the file.

11. The method of claim 9, wherein the second element identifier is also generated as follows:
obtaining the element reference number from the first element identifier and calculating the character length of the element name corresponding to the obtained element reference number;
searching for the obtained element reference number in the content of the file, and obtaining the characters in the content of the file according to the character length of the element name, where the obtained characters are prior to and next to the searched element reference number; and
combining the searched element reference number with the obtained characters to generate the second element identifier in the content of the file.

12. The method of claim 9, wherein the second element identifier corresponds to the first element identifier upon the condition that both the second element identifier and the first element identifier include the same element name or the same element reference number.

13. A non-transitory computer-readable medium having stored thereon instructions that, when executed by a computer, the computer in electronic communication with a client, causing the cloud computer to perform a validating method, the method comprising:
reading an element information list from a file stored in a database of the computer, generating first element identifiers according to the element information list;
validating if each first element identifier in the storage system is the same as a second element identifier corresponding to the first element identifier; and
marking the second element identifier in the content of the file, in response to a determination that the first element identifier is different from the second element identifier corresponding to the first element identifier.

14. The non-transitory computer-readable medium of claim 13, wherein the element information list comprises element names and element reference numbers, and each element name corresponds to one or more element reference numbers.

15. The non-transitory computer-readable medium of claim 14, wherein the first element identifier is generated by combining an element name with an element reference number corresponding to the element name.

16. The non-transitory computer-readable medium of claim 14, wherein second element identifier is generated as follows:
obtaining the element name from the first element identifier and calculating a character length of the element reference number corresponding to the obtained element name;
searching for the obtained element name in the content of the file, and obtaining characters in the content of the file according to the character length of the element reference number, wherein the obtained characters are behind and next to the searched element name; and
combining the searched element name with the obtained characters to generate the second element identifier in the content of the file.

17. The non-transitory computer-readable medium of claim 14, wherein second element identifier is generated as follows:
obtaining the element reference number from the first element identifier and calculating the character length of the element name corresponding to the obtained element reference number;
searching for the obtained element reference number in the content of the file, and obtaining the characters in the content of the file according to the character length of the element name, where the obtained characters are prior to and next to the searched element reference number; and
combining the searched element reference number with the obtained characters to generate the second element identifier in the content of the file.

18. The non-transitory computer-readable medium of claim 14, wherein the second element identifier corresponds to the first element identifier upon the condition that both the second element identifier and the first element identifier include the same element name or the same element reference number.
